(19) United States
(12) Patent Application Publication
(10) Pub. No.: US 2026/0061995 A1
(43) Pub. Date: Mar. 5, 2026

(54) PARKING ASSISTANCE DEVICE AND PARKING ASSISTANCE METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yousuke HATTORI, Tokyo (JP); Riki EGAMI, Tokyo (JP); Keisuke OYAMA, Nisshin-shi (JP)

(21) Appl. No.: 19/384,715

(22) Filed: Nov. 10, 2025

Related U.S. Application Data
(63) Continuation of application No. PCT/JP2024/016260, filed on Apr. 25, 2024.

(30) Foreign Application Priority Data
May 12, 2023 (JP) 2023-079053

(51) Int. Cl. B60W 30/06; B60W 50/14

(52) U.S. Cl. CPC B60W 30/06; B60W 50/14; B60W 2050/143; B60W 2050/146; B60W 2540/215; B60W 2556/50

(57) ABSTRACT

A parking assistance device that assists parking of a vehicle includes: a position acquiring unit that acquires a vehicle position as a position of the vehicle; a route acquiring unit that acquires a plurality of routes as routes from the vehicle position to a plurality of parking positions; a judging unit that judges whether execution of automatic parking is possible, the automatic parking being such that the vehicle travels on any one of the plurality of routes and is parked in the parking position; a suggesting unit that, when execution of the automatic parking is possible, suggests the automatic parking before the vehicle passes through a junction of the plurality of routes; and a parking control unit that executes the automatic parking using the selected route.

### CROSS-REFERENCE TO RELATED APPLICATION

The present application is a continuation application of International Application No. PCT/JP2024/016260, filed on Apr. 25, 2024, which claims priority to Japanese Patent Application No. 2023-079053, filed on May 12, 2023. The contents of these applications are incorporated herein by reference in their entirety.

### BACKGROUND

### Technical Field

The present disclosure relates to a parking assistance device and a parking assistance method.

### Background Art

As a parking assistance device, a technology to automatically park a vehicle in a stored parking lot is known.

### SUMMARY

In the present disclosure, provided is a parking assistance device as the following.

The parking assistance device acquires a vehicle position; acquires a plurality of routes from the vehicle position to each of a plurality of parking positions, the plurality of routes being connected by a junction; judges whether execution of automatic parking is possible, the automatic parking being such that the vehicle travels on at least one of the plurality of routes and is parked in a corresponding one of the plurality of parking positions; when execution of the automatic parking is possible, suggests the automatic parking before the vehicle passes through a junction between a route to a parking position where execution of the automatic parking is possible and another route; and executes the automatic parking using a route for executing the automatic parking that has been suggested.

### BRIEF DESCRIPTION OF THE DRAWINGS

The above-described and other objects, features, and advantages of the present disclosure will become clearer from the following detailed description with reference to the accompanying drawings. The drawings are as follows:

FIG. 1 is a schematic diagram showing a configuration of an automatic driving control system;

FIG. 2 is a flowchart showing an example of an automatic parking suggesting process;

FIG. 3 is a flowchart showing an example of a junction determining process;

FIG. 4 is an illustrative diagram showing an example of a junction; and

FIG. 5 is a flowchart showing an example of a junction determining process in a second embodiment.

### DETAILED DESCRIPTION OF THE PREFERRED EMBODIMENTS

Japanese Unexamined Patent Application Publication (Translation of PCT Application) No. 2013-530867 discloses a technology to automatically park a vehicle in a parking lot from a state of having moved to the vicinity of a desired parking lot by driving by a driver.

There has been a demand for a technology to efficiently perform automatic parking in any of a plurality of parking lots existing around the current position.

The present disclosure has been made for solving the above-described problems and can be realized as the following aspects.

According to an aspect of the present disclosure, there is provided a parking assistance device that assists parking of a vehicle. This parking assistance device includes: a position acquiring unit configured to acquire a vehicle position as a position of the vehicle; a route acquiring unit configured to acquire a plurality of routes from the vehicle position to each of a plurality of parking positions, the plurality of routes being connected by a junction; a judging unit configured to judge whether execution of automatic parking is possible, the automatic parking being such that the vehicle travels on at least one of the plurality of routes and is parked in a corresponding one of the plurality of parking positions; a suggesting unit configured to, when execution of the automatic parking is possible, suggest the automatic parking before the vehicle passes through a junction between a route to a parking position where execution of the automatic parking is possible and another route; and a parking control unit configured to execute the automatic parking using a route for executing the automatic parking that has been suggested.

According to the parking assistance device of this aspect, automatic parking is suggested before the vehicle passes through the junction of the plurality of routes, so that automatic parking can be suggested at a location where the vehicle can move without returning to any parking lot. Therefore, when a plurality of parking lots exists around the vehicle, automatic parking in any parking lot can be efficiently performed.

### A. First Embodiment

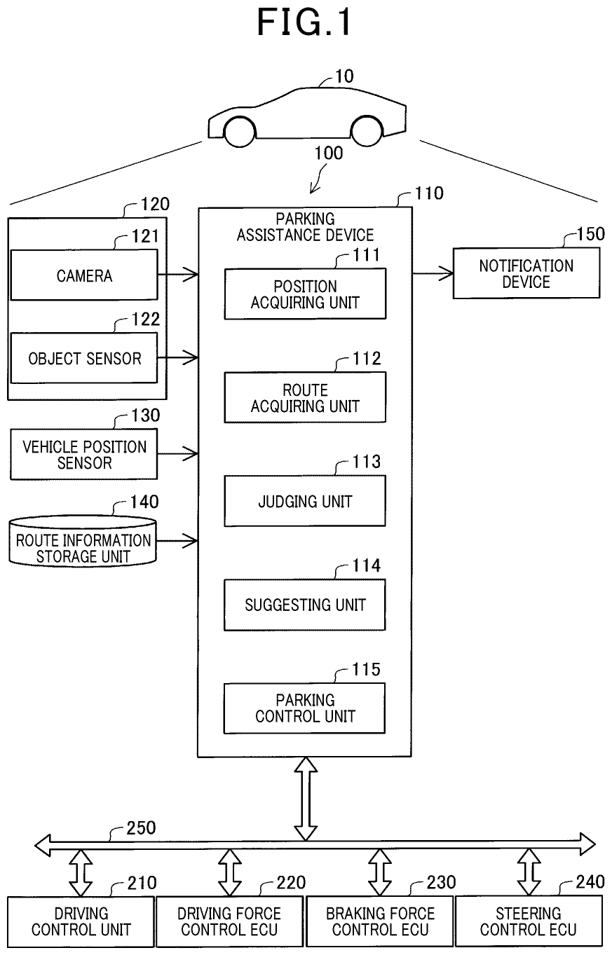

As shown in FIG. 1, a vehicle 10 includes an automatic driving control system 100. In the present embodiment, the automatic driving control system 100 executes automatic driving of the vehicle 10. In the present embodiment, the automatic driving control system 100 includes a parking assistance device 110, a periphery sensor 120, a vehicle position sensor 130, a route information storage unit 140, a notification device 150, an automatic driving control unit 210, a driving force control electronic control unit (ECU) 220, a braking force control ECU 230, and a steering control ECU 240. The parking assistance device 110, the driving force control ECU 220, the braking force control ECU 230, and the steering control ECU 240 are connected via an on-board network 250. Note that the vehicle 10 may be driven by not only automatic driving but also manual driving manually performed by a driver.

The periphery sensor 120 is a sensor capable of detecting a target positioned on the periphery of the vehicle 10. The periphery sensor 120 includes a camera 121 and an object sensor 122. The camera 121 takes and acquires an image of the periphery of the vehicle 10. The object sensor 122 detects a situation on the periphery of the vehicle 10. An example of the object sensor 122 is a laser radar using a reflected wave.

The vehicle position sensor 130 detects the vehicle position of the vehicle 10. An example of the vehicle position sensor 130 is a global navigation satellite system (GNSS) such as a global positioning system (GPS).

The route information storage unit 140 stores, for example, detailed route information regarding a route when parking in a parking position was performed in the past. An example of the route information is information including a parking position, a movement history from a parking position, a position of a vehicle in a road or a parking lot, the number of lanes, a lane width, a center co-ordinate of each lane, a curvature, a stop line position, a signal position, and the like. Hereinafter, the route stored in the route information storage unit 140 is also referred to as a “registered route”.

The parking assistance device 110 is a device that automatically parks the vehicle 10. The parking assistance device 110 is constituted by a computer including a central processing unit (CPU), a RAM, and a ROM, and the CPU executes a program previously installed in a storage area such as the RAM and the ROM of the parking assistance device 110 to realize functions of a position acquiring unit 111, a route acquiring unit 112, a judging unit 113, a suggesting unit 114, and a parking control unit 115. However, the functions of these units may be partly or entirely realized by a hardware circuit. Hereinafter, a case of suggesting automatic parking when manual driving is performed will be described as an example.

The position acquiring unit 111 acquires vehicle position information from the vehicle position sensor 130.

The route acquiring unit 112 acquires a plurality of routes as routes from the vehicle position acquired by the position acquiring unit 111 to a plurality of parking positions, from the route information storage unit 140. In the present embodiment, any of the routes is represented by a plurality of points having a predetermined distance interval.

The judging unit 113 judges whether it is possible to execute automatic parking of parking the vehicle 10 in the parking position using any one of the plurality of routes. In the present embodiment, the judging unit 113 judges that it is possible to execute automatic parking when a judgement condition is satisfied. As the judgement condition, for example, one or more of the following conditions can be adopted.

### <Condition 1>

The vehicle speed of the vehicle 10 is equal to or less than a predetermined judgement speed.

### <Condition 2>

No obstacle exists in front of the vehicle 10.

### <Condition 3>

When the vehicle 10 is positioned on the registered route, an angle formed between the vector of the traveling direction of the vehicle 10 and the vector of the traveling direction of the registered route is equal to or less than a predetermined judgement angle.

The judgement speed in the above-described condition 1 is, for example, 50 km/h.

The judgement angle in the above-described condition 3 is, for example, 5 degrees.

Further, the judgement condition may also be an appropriate combination of the above-described conditions 1 to 3 and other conditions. In the present embodiment, the above-described condition 1, condition 2, and condition 3 are adopted as the judgement condition, and the judging unit 113 judges that the judgement condition is established when all of these condition 1, condition 2, and condition 3 are established.

The suggesting unit 114 suggests automatic parking before the vehicle 10 passes through a junction, using the current vehicle position, when the judging unit 113 judges that it is possible to execute automatic parking. Details of determination of the junction will be described later. In the present embodiment, the suggesting unit 114 suggests automatic parking to the driver of the vehicle 10 via the notification device 150.

The parking control unit 115 causes the vehicle 10 to travel on the selected route and executes automatic parking. More specifically, the parking control unit 115 instructs the automatic driving control unit 210 to control accelerator operation and steering wheel operation to cause the vehicle 10 to travel on the selected route to the parking position by automatic driving and automatically park the vehicle 10 in the parking position. Further, the parking control unit 115 instructs the automatic driving control unit 210 to perform control for automatically parking the vehicle 10 from the vicinity of the parking position in the parking position, using information indicating the position of a target on the periphery of the vehicle 10 acquired from the periphery sensor 120.

The notification device 150 notifies the driver of the vehicle 10 of the suggestion of automatic parking by the suggesting unit 114. The notification device 150 notifies about the suggestion of automatic parking using, for example, a display device, such as a car navigation, that shows letters and pictures, and a voice device such as a speaker. The notification device 150 notifies, as the suggestion of automatic parking, about, for example, the registered route on which the vehicle 10 is planned to travel and the parking position in automatic parking.

The automatic driving control unit 210 is constituted by a microcomputer including a central processing unit (CPU), a RAM, and a ROM, and the like, and the microcomputer executes a previously installed program to realize the automatic driving function. The automatic driving control unit 210 realizes the automatic driving function by controlling the driving force control ECU 220, the braking force control ECU 230, and the steering control ECU 240. The automatic driving control unit 210 controls, for example, the driving force control ECU 220 and the braking force control ECU 230 to automatically change the lane using the steering control ECU 240.

The driving force control ECU 220 is an electronic control device that controls a power source, such as an engine, that generates a driving force of the vehicle 10. When the driver performs manual driving, the driving force control ECU 220 controls a power source as an engine or an electric motor depending on the operation amount of an accelerator pedal. When automatic driving is performed, the driving force control ECU 220 controls a power source depending on a required driving force calculated in the automatic driving control unit 210.

The braking force control ECU 230 is an electronic control device to control a brake actuator that generates a braking force of the vehicle 10. When the driver performs manual driving, the braking force control ECU 230 controls a brake actuator depending on the operation amount of a brake pedal. When automatic driving is performed, the braking force control ECU 230 controls a brake actuator depending on a required braking force calculated in the automatic driving control unit 210.

The steering control ECU 240 is an electronic control device to control a motor that generates steering torque of the vehicle 10. When the driver performs manual driving, the steering control ECU 240 controls a motor depending on the operation of a steering handle to generate assist torque for steering operation. This allows the driver to operate steering with a small amount of force and realizes steering of the vehicle 10. When automatic driving is performed, the steering control ECU 240 controls a motor depending on a required steering angle calculated in the automatic driving control unit 210 thereby to perform steering.

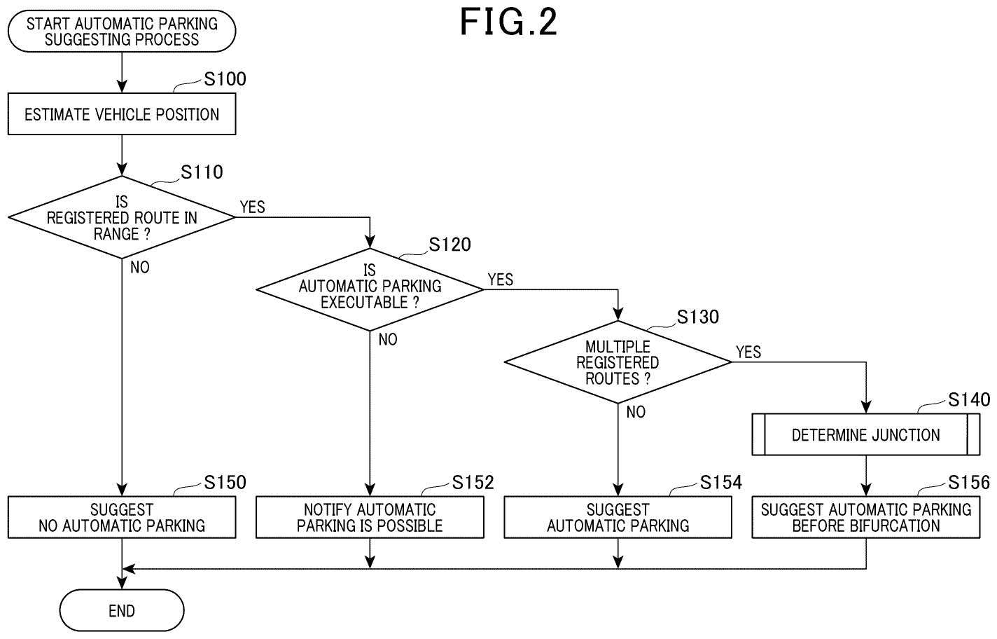

An automatic parking suggesting process illustrated in FIG. 2 is a process in which the parking assistance device 110 suggests automatic parking. The automatic parking suggesting process in the parking assistance method in the present embodiment is a process of suggesting automatic parking before the vehicle 10 passes through a junction of a plurality of registered routes existing in a predetermined range from the current vehicle position. This process is a process repeatedly executed by the parking assistance device 110 during travelling of the vehicle 10, and is, for example, a process repeatedly executed every 100 ms.

In step S100, the parking assistance device 110 acquires a vehicle position from the vehicle position sensor 130. This step is also referred to as a “position acquiring step”.

In step S110, the parking assistance device 110 judges whether a registered route on which the vehicle 10 can travel exists in a predetermined judgement range. More specifically, the parking assistance device 110 judges whether a travelling distance from the vehicle position acquired in step S100 to where the vehicle 10 travels on the registered route is equal to or less than a predetermined judgement distance. The judgement distance is, for example, a value of 0 m or more and 500 m or less. When the travelling distance to any one or more registered routes is equal to or less than the judgement distance, i.e., when a registered route on which the vehicle 10 can travel exists in the judgement range, it is allowed to proceed to the process of step S120. On the other hand, when the travelling distance to all the registered routes is greater than the judgement distance, i.e., when no registered route on which the vehicle 10 can travel exists in the judgement range, the parking assistance device 110 proceeds to the process of step S150 and ends the automatic parking suggesting process without suggesting automatic parking.

In step S120, the parking assistance device 110 judges whether it is possible to execute automatic parking. More specifically, the judging unit 113 judges whether the judgement condition is satisfied. This step is also referred to as a “judging step”. When the judgement condition is satisfied, i.e., when it is possible to execute automatic parking, the parking assistance device 110 proceeds to the process of step S130. On the other hand, when the judgement condition is not satisfied, i.e., when automatic parking cannot be executed, the parking assistance device 110 proceeds to the process of step S152, notifies about existence of a parking position in the range, and ends the automatic parking suggesting process. Note that the parking assistance device 110 may execute step S150 instead of step S152.

In step S130, the parking assistance device 110 judges whether a plurality of registered routes on which the vehicle 10 can travel exists in the judgement range. When a plurality of registered routes on which the vehicle can travel exists in the judgement range, the parking assistance device 110 acquires, from the route information storage unit 140, a plurality of registered routes on which the vehicle 10 can travel, and proceeds to the process of step S140. This step is also referred to as a “route acquiring step”. On the other hand, when only one registered route on which the vehicle 10 can travel exists in the judgement range, the parking assistance device 110 proceeds to the process of step S154, suggests automatic parking, and ends the automatic parking suggesting process. In step S154 in the present embodiment, the suggesting unit 114 notifies about the registered route and the parking position via the notification device 150.

In step S140, the parking assistance device 110 determines a junction of a plurality of routes as routes to a plurality of parking positions existing in the judgement range. Details of the determination of the junction will be described later.

In step S156, the parking assistance device 110 suggests automatic parking before the vehicle 10 passes through the junction determined in step S140. This step is also referred to as a “suggesting step”. In the present embodiment, the suggesting unit 114 suggests automatic parking at a location where a distance between the vehicle 10 and the junction is equal to or less than a predetermined suggestion distance. The suggestion distance is, for example, 50 m. Further, in the present embodiment, the suggesting unit 114 notifies about a plurality of registered routes existing in the judgement range via the notification device 150. For example, the suggesting unit 114 suggests registered routes in order of the parking position closer to the vehicle position. The parking assistance device 110 causes the vehicle 10 to travel on the route selected by the driver of the vehicle 10 and performs automatic parking. This step is also referred to as a “parking control step”.

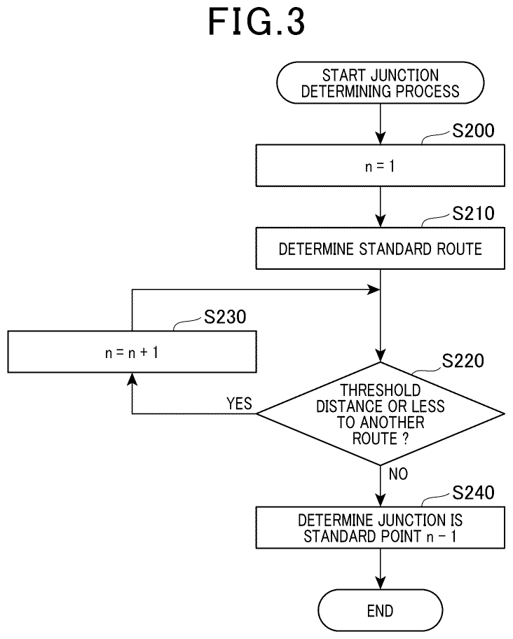

A junction determining process shown in FIG. 3 is a process in which the parking assistance device 110 determines a junction in step S140 (see FIG. 2). First, in step S200, the parking assistance device 110 sets a counter variable n to 1.

In step S210, the parking assistance device 110 determines a standard route among a plurality of registered routes on which the vehicle 10 can travel existing in the judgement range. The parking assistance device 110 can optionally determine a standard route. Note that in the junction determining process, the registered route is a route containing a travelling route from the vehicle position to on the registered route. Hereinafter, a route different from the standard route among the plurality of registered routes on which the vehicle 10 can travel existing in the judgement range is referred to as another route. The order of step S200 and step S210 is not limited to the above, and can be optional, and the steps may be performed at the same time.

In step S220, the parking assistance device 110 judges whether a distance between the nth point (hereinafter, referred to as a “standard point n”) representing the standard route when seen in order from the vehicle 10 and a point of another route corresponding to the standard point n is equal to or less than a predetermined threshold distance. The threshold distance is, for example, 30 cm. In the present embodiment, the point corresponding to the standard point n is the nth point (hereinafter, referred to as a “corresponding point n”) representing another route when seen in order from the vehicle 10. When a distance between the standard point n and the corresponding point n is greater than the threshold distance, the parking assistance device 110 proceeds to the process of step S240. On the other hand, when a distance between the standard point n and the corresponding point n is equal to or less than the threshold distance, the parking assistance device 110 increments the variable n by one in step S230 and returns to the process of step S220. That is, the processes of steps S220 to S230 are repeated until the traveling direction of the standard route and the traveling direction of another route differ.

In step S240, the parking assistance device 110 determines the junction as the standard point n−1. That is, in the present embodiment, the parking assistance device 110 determines the junction as a point immediately preceding the standard point at which the distance between the standard point and the corresponding point becomes equal to or greater than the threshold distance for the first time when seen in order from the vehicle 10.

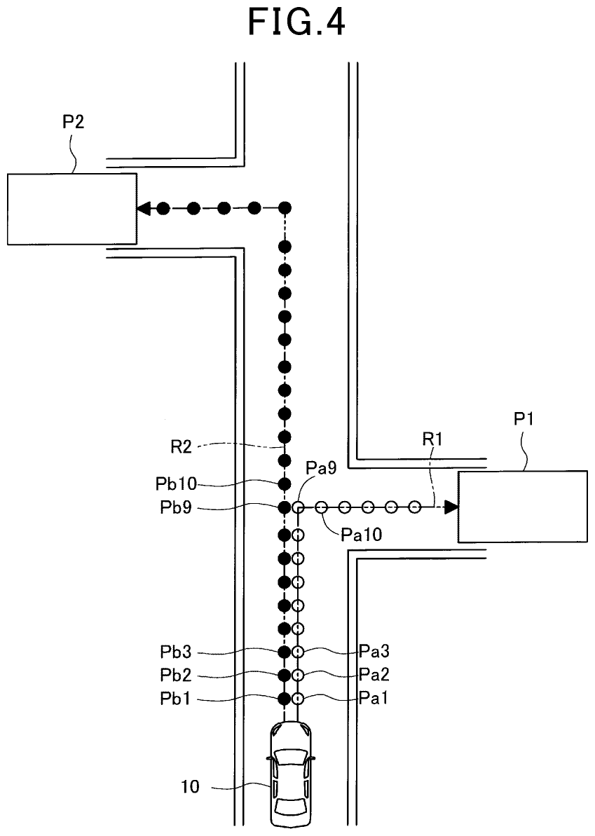

As shown in FIG. 4, the junction determining process will be described in an example in which a first route R1 and a second route R2 exist in the judgement range. More specifically, FIG. 4 shows a case where the vehicle 10 is positioned on the first route R1 and the second route R2. In FIG. 4, the first route R1 as a route from the vehicle 10 to a first parking position P1 is indicated by a row of open circle points, and the second route R2 as a route from the vehicle 10 to a second parking position P2 is indicated by a row of filled circle points. Note that the second route R2 is shifted to the left direction in the drawing for convenience of explanation, but actually the second route R2 partially overlaps, in the row of points indicating the first route R1, with the first route R1 from the vehicle 10 to a point Pa9 that is the 9th point when seen in order from the vehicle 10. Hereinafter, an example in which the first route R1 is determined as the standard route will be described.

When the process of step S220 (see FIG. 3) is executed for the first time after the junction determining process started, i.e., when n=1, a distance between a standard point Pa1 in the row of points indicating the first route R1 as the first point when seen in order from the vehicle 10 and a corresponding point Pb1 is equal to or less than the threshold distance, so that it is allowed to proceed to the process of step S230, the variable n is incremented by one, and the process of step S220 is repeated.

When n=2, a distance between a standard point Pa2 and a corresponding point Pb2 is also equal to or less than the threshold distance, so that it is allowed to proceed to the process of step S230, and the process of step S220 is repeated. When n=3 to 9, the processes of steps S220 to S230 are similarly repeated.

In step S230 when n=10, a distance between a standard point Pa10 and a corresponding point Pb10 is greater than the threshold distance, so that it is allowed to proceed to the process of step S240, and it is determined that the junction is the standard point Pa9 that is immediately preceding the standard point Pa10.

According to the parking assistance device 110 of the present embodiment described above, automatic parking is suggested before the vehicle 10 passes through the junction of the plurality of routes, so that automatic parking can be suggested at a location where the vehicle 10 can move without returning to any parking lot. Therefore, when a plurality of parking lots exists around the vehicle 10, automatic parking can be efficiently performed in any parking lot.

Further, the parking assistance device 110 determines the junction as a point in the row of points indicating the standard route at which a distance between the row of points indicating the standard route and the row of points indicating another route different from the standard route becomes equal to or greater than the threshold distance for the first time when seen in order from the vehicle 10. Therefore, it can be determined that the junction is the point Pa9 at which the standard route closest from the vehicle 10 and another route diverge.

Further, the parking assistance device 110 causes the vehicle 10 to travel on the route selected by the driver of the vehicle 10 among suggested routes and performs automatic parking. Therefore, the parking assistance device 110 can suggest a plurality of routes to the driver of the vehicle 10.

### B. Second Embodiment

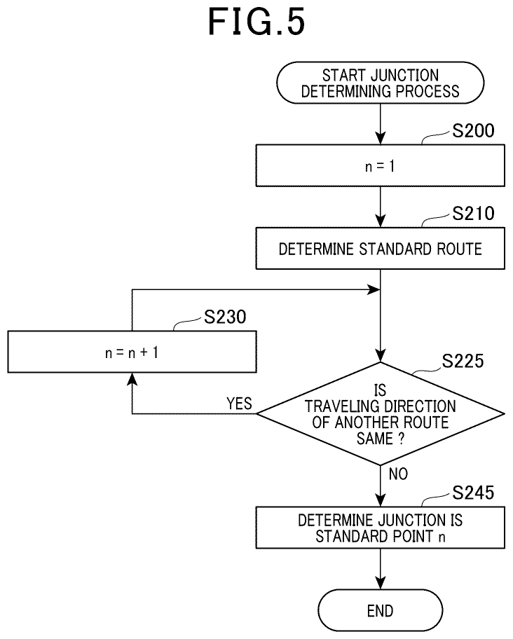

A junction determining process of a second embodiment shown in FIG. 5 is the same as the first embodiment except that the processes of step S225 and step S245 are executed instead of the processes of step S220 and step S240. The configuration of the parking assistance device 110 of the second embodiment is the same as the configuration of the parking assistance device 110 of the first embodiment, so that description of the configuration of the parking assistance device 110 will be omitted.

In step S225, the parking assistance device 110 judges whether the traveling direction of the standard route and the traveling direction of another route are the same. More specifically, it is judged whether an angle formed between a vector from a standard point n to a standard point n+1 and a vector from a corresponding point n to a corresponding point n+1 is equal to or less than a predetermined threshold angle. The threshold angle may be, for example, 5 degrees. When the traveling directions differ, the parking assistance device 110 proceeds to the process of step S245. On the other hand, when the traveling directions are the same, the parking assistance device 110 increments a variable n by one in step S230 and returns to the process of step S225. That is, the processes of steps S225 to S230 are repeated until the traveling direction of the standard route and the traveling direction of another route differ.

In step S245, the parking assistance device 110 determines the junction as a standard point n. That is, in the present embodiment, the parking assistance device 110 determines the junction as a point in the row of points indicating the standard route at which the traveling direction of the row of points indicating the standard route and the traveling direction of the row of points indicating another route different from the standard route differ for the first time when seen in order from the vehicle 10.

The effects of the second embodiment are substantially the same as those of the first embodiment.

### C. Other Embodiments

(C1) In the above-described embodiment, the parking assistance device 110 suggests automatic parking when manual driving is performed. However, the parking assistance device 110 is not limited to this configuration and may suggest automatic parking when automatic driving is performed. For example, the parking assistance device 110 executes the automatic parking suggesting process when the vehicle 10 arrives at the vicinity of the destination. Accordingly, automatic parking can be efficiently suggested and executed even when automatic driving ends on a local road in the vicinity of the destination or when a plurality of parking positions exists in the site of the destination.

(C2) In the above-described embodiment, the route acquiring unit 112 acquires a route stored in the route information storage unit 140. However, the route acquiring unit 112 is not limited to this configuration and may search routes from the vehicle position acquired by the position acquiring unit 111 to a plurality of parking positions, using road information stored in the route information storage unit 140.

(C3) In the above-described embodiment, the parking assistance device 110 determines the junction in the automatic parking suggesting process. However, the parking assistance device 110 is not limited to this configuration and may acquire a previously calculated junction. For example, the junction may be stored in the route information storage unit 140.

(C4) In the above-described embodiment, the parking assistance device 110 suggests automatic parking at a location where a distance between the vehicle 10 and the junction becomes equal to or less than the predetermined suggestion distance. However, the parking assistance device 110 is not limited to this configuration. For example, the parking assistance device 110 may suggest automatic parking at a location where a time to arrival of the vehicle 10 at the junction becomes equal to or less than a predetermined suggestion time.

(C5) In the above-described embodiments, the suggesting unit 114 notifies about a plurality of parking positions existing in the judgement range via the notification device 150 in step S156 (see FIG. 2). However, the suggesting unit 114 is not limited to this configuration. For example, the suggesting unit 114 may suggest automatic parking in a parking position closest from the vehicle position, and may suggest automatic parking in another parking position when the suggestion has not been accepted.

(C6) In the above-described first embodiment, the parking assistance device 110 determines the junction as a point in the row of points indicating the standard route at which a distance between the row of points indicating the standard route and the row of points indicating another route becomes equal to or greater than the predetermined threshold distance for the first time when seen in order from the vehicle 10. However, the parking assistance device 110 is not limited to this configuration. For example, the parking assistance device 110 may determine that the junction is a point in the row of points indicating the standard route at which a distance between the row of points indicating the standard route and the row of points indicating another route becomes equal to or less than the predetermined threshold distance for the first time when seen in order from the parking position.

The present disclosure is not limited to the above-described embodiments, and can be realized in various configurations within the scope that does not depart from the spirit thereof. For example, the technical features in the embodiments corresponding to the technical features in the aspects described in Summary can be appropriately replaced or combined in order to solve the above-described problems or in order to achieve a part or the entirety of the above-described effects. Further, the technical features can be appropriately deleted if not described as essential herein.

The components such as the position acquiring unit and the methods thereof according to the present disclosure may be realized by a dedicated computer that is provided by constituting a processor programmed to execute one or more functions embodied by a computer program, and a memory. Alternatively, the components such as the position acquiring unit and the methods thereof according to the present disclosure may be realized by a dedicated computer provided by constituting a processor with one or more dedicated hardware logic circuits. Alternatively, the components such as the position acquiring unit and the methods thereof according to the present disclosure may be realized by one or more dedicated computers constituted by a combination of a processor programmed to execute one or more functions and a memory, and a processer constituted by one or more hardware logic circuits. A computer program may be stored as an instruction to be executed by a computer in a computer-readable non-transitory tangible storage medium.

What is claimed is:

1. A parking assistance device that assists parking of a vehicle, comprising:
a position acquiring unit configured to acquire a vehicle position as a position of the vehicle;
a route acquiring unit configured to acquire a plurality of routes from the vehicle position to each of a plurality of parking positions, the plurality of routes being connected by a junction;
a judging unit configured to judge whether execution of automatic parking is possible, the automatic parking being such that the vehicle travels on at least one of the plurality of routes and is parked in a corresponding one of the plurality of parking positions;
a suggesting unit configured to, when execution of the automatic parking is possible, suggest the automatic parking before the vehicle passes through a junction between a route to a parking position where execution of the automatic parking is possible and another route; and
a parking control unit configured to execute the automatic parking using a route for executing the automatic parking that has been suggested.

2. The parking assistance device according to claim 1,
wherein the suggesting unit is configured to determine the junction as a standard point immediately preceding a standard point at which a distance between each of a plurality of standard points and a corresponding one of a plurality of corresponding points becomes equal to or greater than a predetermined threshold distance for the first time when seen in order from the vehicle, the plurality of standard points indicating a standard route that is one of the plurality of routes, and the plurality of corresponding points being points on another route that is a route different from the standard route and corresponding to the plurality of standard points respectively.

3. The parking assistance device according to claim 1, wherein
the suggesting unit is configured to suggest the plurality of routes, and
the parking control unit is configured to perform the automatic parking in which the vehicle travels on the route selected by a driver of the vehicle.

4. The parking assistance device according to claim 2, wherein
the suggesting unit is configured to suggest the plurality of routes, and
the parking control unit is configured to perform the automatic parking in which the vehicle travels on the route selected by a driver of the vehicle.

5. The parking assistance device according to claim 1, wherein
the suggesting unit is configured to perform the suggestion at a location where a distance between the vehicle and the junction is equal to or less than a predetermined suggestion distance.

6. The parking assistance device according to claim 2, wherein
the suggesting unit is configured to perform the suggestion at a location where a distance between the vehicle and the junction is equal to or less than a predetermined suggestion distance.

7. The parking assistance device according to claim 1,
wherein the suggesting unit is configured to perform the suggestion at a location where a time to arrival of the vehicle at the junction is equal to or less than a predetermined suggestion time.

8. The parking assistance device according to claim 2,
wherein the suggesting unit is configured to perform the suggestion at a location where a time to arrival of the vehicle at the junction is equal to or less than a predetermined suggestion time.

9. A parking assistance method executed by a parking assistance device that assists parking of a vehicle, comprising:
a position acquiring step of acquiring a vehicle position as a position of the vehicle;
a route acquiring step of acquiring a plurality of routes from the vehicle position to each of a plurality of parking positions, the plurality of routes being connected by a junction;
a judging step of judging whether execution of automatic parking is possible, the automatic parking being such that the vehicle travels on at least one of the plurality of routes and is parked in a corresponding one of the plurality of parking positions;
a suggesting step of suggesting, when execution of the automatic parking is possible, the automatic parking before the vehicle passes through a junction between a route to a parking position where execution of the automatic parking is possible and another route; and
a parking control step of executing the automatic parking using a route for executing the automatic parking that has been suggested.
